(19) United States
(12) Patent Application Publication
(10) Pub. No.: US 2016/0125863 A1
(43) Pub. Date: May 5, 2016

(54) INTEGRATED HIGH SAMPLE RATE DIGITAL AUDIO WORKSTATION WITH EMBEDDED CONVERTERS

(71) Applicant: iZ Technology Corporation, Port Coquitlam (CA)

(72) Inventor: Barry Henderson, Port Coquitlam (CA)

(21) Appl. No.: 14/928,202

(22) Filed: Oct. 30, 2015

Related U.S. Application Data
(60) Provisional application No. 62/072,670, filed on Oct. 30, 2014.

(51) Int. Cl. G10H 1/00

(52) U.S. Cl. CPC G10H 1/0058; G10H 2220/096; G10H 2240/325; G10H 2240/016

(57) ABSTRACT

A standalone integrated digital audio workstation (DAW) including: a single housing; embedded multi-channel analog-to-digital (A/D) and digital-to-analog (D/A) converters within the single housing; a recording engine, coupled to the A/D and D/A converters for recording multiple tracks of audio at one or more sampling rates using a near-zero jitter clock signal in a record mode; recording media for storing the multiple tracks to create native recording files during the recording mode; and one or more processors, within the single housing, to edit, mix, and prepare final production files without the use of a separate computer in a DAW mode using directly the native recording files. Embodiments also relate to a studio system with a DAW and method of use.

### CROSS-REFERENCE TO RELATED APPLICATIONS

This application claims priority benefit to U.S. Provisional Patent Application No. 62/072,670 filed Oct. 30, 2014, entitled “INTEGRATED HIGH SAMPLE RATE DIGITAL AUDIO WORKSTATION WITH EMBEDDED CONVERTERS” incorporated herein by reference in its entirety.

### FIELD OF THE DISCLOSURE

The disclosure generally relates to devices for recording, editing and producing audio recordings and more particularly to fully integrated digital audio workstations having a general purpose computing environment and embedded high sample rate multi-channel analogue to digital and digital to analog converters.

### BACKGROUND

The statements in this section merely provide background information related to the present disclosure and may not constitute prior art.

Current computer-based digital audio workstations (DAWs) require a custom system to be built by the end user. The purchasing, installing, configuring, testing, and optimizing of the myriad required components, often from several manufacturers is a time consuming and often frustrating experience.

Traditionally, professional audio recording in the recording industry utilized magnetic tape-based dedicated recording devices. Multitrack recordings would be created on a single tape wherein multiple pickups would record sound onto multiple tracks on a tape. Each pickup is from a single microphone source. The simplest form of multitrack recording is a stereo recording where audio of a single performance is picked up by two microphones separated a distance from one another and recording on a tape or other medium. Multitrack recording enables simultaneous or separate recording of specific portions of an audio composition, such as a musical number. For example, one track may be used to record only the lead vocals, on another track may be recorded the percussion line, on a third track, backup vocals may be recorded and on a fourth track a guitar performance may be recorded. Multitrack recording enables each track to be edited, rerecorded, or otherwise altered independently of the other tracks, thereby giving the audio engineer greater control over the final composition. Each track may record audio from a dedicated microphone. Professionally produced music (e.g., pop singles produced for mainstream distribution) commonly uses 24 or more tracks to record a single song or other composition. Furthermore 12 or more microphones, each being recorded on a single track, maybe used to record the performance of a single drum kit.

Multitrack recordings remain the standard and most preferable way to record musical compositions, therefore any professional or otherwise high quality recording and mixing device must provide multitrack recording capabilities.

Digitally recording musical compositions offers many advantages including, but not limited to, ease of reproduction, smaller equipment, and digital storage does not “wear out” (i.e., there typically is no reduction in quality of a track if it is played many times).

As the recording industry moved from dedicated analog audio production tools to computer-based, digital audio production tools, problems arose which have yet to be fully addressed. Audio engineers, music producers and other individuals seek to create a system which enables the recording of an audio composition, editing the composition on a multitrack level and producing or mastering the finished version or versions. Current offerings are consumer computer-based and centered around audio recording and editing suites such as Pro Tools® (available from Avid Technologies, Inc. of Burlington, Mass.). In order to create a platform capable of recording, mixing, and editing a musical performance or other audio composition, an individual must buy multiple hardware and software components from different vendors in different enclosures networked to communicatively coupled together.

The individual must learn about the specifications of each component and the requirements of the underlying software in order to have a chance of creating a working system. Typically, audio engineers are not well versed in the intricacies and interrelationships of the hardware and software powering a recording studio, therefore while software-based audio recording and editing suites are powerful and capable of simultaneously recording a multitude of tracks, a steep learning curve is present. Furthermore, such software is released independently of the hardware cobbled together by the user. Often times, every component of a customized recording and mixing system are not optimized for new software releases. In some cases, some components may be incompatible with subsequent software releases. Such custom systems are technologically fragile and place an increased burden of system architecting and maintenance on the end user.

Both consumers and producers of music seek so called “high-resolution audio.” Generally, high-resolution audio (HRA), is digital audio capable of being played back at 24-bit/192 kHz rates. As of 2014, digital audio delivered by the largest providers of such content (e.g., the Apple iTunes music store available from Apple, Inc. of Cupertino, Calif.) has a sample rate maximum of 96 kHz. Algorithms and other processes may be applied to such low-sample rate files in order to up them to HRA-level rates, however fidelity is lost compared to an audio track recorded and mastered at 192 kHz.

Many music producers have long sought or otherwise demanded to do recordings at high sample rates in order to capture the truest recordings. For example, Neil Young insists on recording albums at 192 kHz and encourages consumers to seek out higher resolution recordings because they provide a truer sound and greater musical range. Current MP3s sold by iTunes and other providers contain only five percent of the audio information found in a 192 kHz studio recording.

Given the foregoing, what is needed is an integrated hardware and software solution for audio recording and editing. Previous attempts have been made to solve such problems, for example the Tascam X-48 workstation (available from Teac Corporation of Tokyo, Japan). Such systems are deficient either because they cannot record audio at sufficiently high sample rates (e.g., 192 kHz) for some professional recordings, or they cannot run third party audio software and plugins. As such, what is needed is a standalone integrated digital audio workstation comprising both recording hardware such as A/D and D/A converters and third party editing software and plugins which can record multiple tracks at sampling rates sufficient for professional production (e,g., 192 kHz).

Additionally, what is needed are dedicated recording and editing systems comprising both hardware and software wherein the hardware is upgradable and fully supported by a single company.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the disclosure provide a standalone integrated digital audio workstation (DAW) including: a single housing and embedded multi-channel analog-to-digital (A/D) and digital-to-analog (D/A) converters within the single housing. The DAW includes a recording engine, coupled to the A/D and D/A converters for recording multiple tracks of audio at one or more sampling rates using a near-zero jitter clock signal in a record mode; and recording media for storing the multiple tracks to create native recording files during the recording mode. One or more processors, within the single housing, edit, mix, and prepare final production files without the use of a separate computer in a DAW mode using directly the native recording files.

Another aspect of the disclosure includes a standalone integrated digital audio workstation (DAW) system comprising: a DAW in a single housing. The DAW comprises embedded multi-channel analog-to-digital (A/D) and digital-to-analog (D/A) converters within the single housing; a recording engine, coupled to the A/D and D/A converters for recording multiple tracks of audio at one or more sampling rates using a near-zero jitter clock signal in a record mode; recording media for storing the multiple tracks to create native recording files during the recording mode; one or more processors, within the single housing, to edit, mix, and prepare final production files without the use of a separate computer in a DAW mode using directly the native recording files The system includes a dual mode session controller remote coupled to the single housing and configured to control operations of the recording engine in the recording mode and the one or more processors in the DAW mode.

Another aspect of the disclosure includes a method comprising: providing a digital audio workstation (DAW) in a single housing, the DAW comprising embedded multi-channel analog-to-digital (A/D) and digital-to-analog (D/A) converters within the single housing; a recording engine, coupled to the A/D and D/A converters for recording multiple tracks of audio at one or more sampling rates using a near-zero jitter clock signal in a record mode; recording media for storing the multiple tracks to create native recording files during the recording mode; and one or more processors, within the single housing, to edit, mix, and prepare final production files in a DAW mode using directly the native recording files wherein the DAW has a low aggregate latency; recording with the DAW in the recording mode to create the native recording files; and editing and mixing the native recording files in the DAW mode without use of a separate of a separate computer.

Further features and advantages of the disclosure, as well as the structure and operation of various aspects of the disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of a studio system with a standalone integrated digital audio workstation (DAW), according to an aspect of the disclosure.

FIG. 2 is a block diagram of a standalone integrated digital audio workstation (DAW), according to an aspect of the disclosure.

FIGS. 3A and 3B, are a front panel and a back panel of a standalone integrated digital audio workstation (DAW), according to an aspect of the disclosure.

FIG. 4 is a block diagram of an exemplary computing system useful for implementing aspects of the disclosure.

FIG. 5 is a diagram of a session controller remote (SCR) with a meterbridge, according to an aspect of the disclosure.

FIG. 6 is a flowchart of a dual mode integrated DAW system operational process, according to an aspect of the disclosure.

FIG. 7 is a networked integrated DAW system, according to an aspect of the disclosure.

### DETAILED DESCRIPTION

The disclosure is directed to audio recording, editing, and mixing within a single integrated system within a single enclosure. Furthermore, recording is done at high sample rates suitable for professional recording and editing (e.g., 192 kHz).

Recording and editing systems in accordance with the present disclosure are standalone integrated digital audio workstation (DAW) comprising both recording hardware including the multi-channel A/D and D/A converters, and third party editing software which can record multiple tracks at sampling rates sufficient for professional production (e.g., 192 kHz). Such systems enable a user to record, edit, mix, and prepare final production files in a single box (housing) without the use of a separate computer. As will be apparent to those skilled in the relevant art(s) after reading the description herein, the system may have any desired functionality found in software-based digital audio workstations. Systems in accordance with the disclosure are optimized for high quality operation and utilization of all included features recording, editing, overdubbing, synchronizing, and mixing. Such systems utilize off the shelf components, enabling the user to upgrade the system upgradable over time.

The inventors have determined that minimization of clock jitter is a factor in producing quality recording and mixing. Clock jitter is very small variations in the period of the sample clock from one cycle to the next. Even small amounts of clock jitter, as low as the picosecond range, will result in odd and even harmonics in recorded audio not present in the original audio source. Minimization of clock jitter requires a low jitter source, an extremely clean clock power supply, and microstrip impedance matched, balanced, differential clock signal lines between the clock source and the analogue to digital and digital to analogue converters. The inventors have determined that this topology is not possible in a modular, distributed system where the converters are external to the computing environment since there are currently no standards or methods to extend such signals outside of the computer housing without the injection of noise into the recorded audio. In mixing, outputs to speakers can be affected by the clock jitter such that the output may not be an accurate representation of the sound.

Additionally, the inventors have determined that minimization of latency and maintaining high sampling rates is paramount for quality recording and mixing in such contexts. Minimization of audio latency is difficult because the user does not have the technical capability to understand the combined latency factors of the aggregate components, and how to minimize the latency, thus, the audio performance of the system is often compromised. Such component incompatibilities evolve and are exacerbated over time as software (both the recording application and the computer operating system) and system components change. Latency is minimized because the native recording files do not travel remotely during editing and mixing, especially when mixing a large number of tracks/channels.

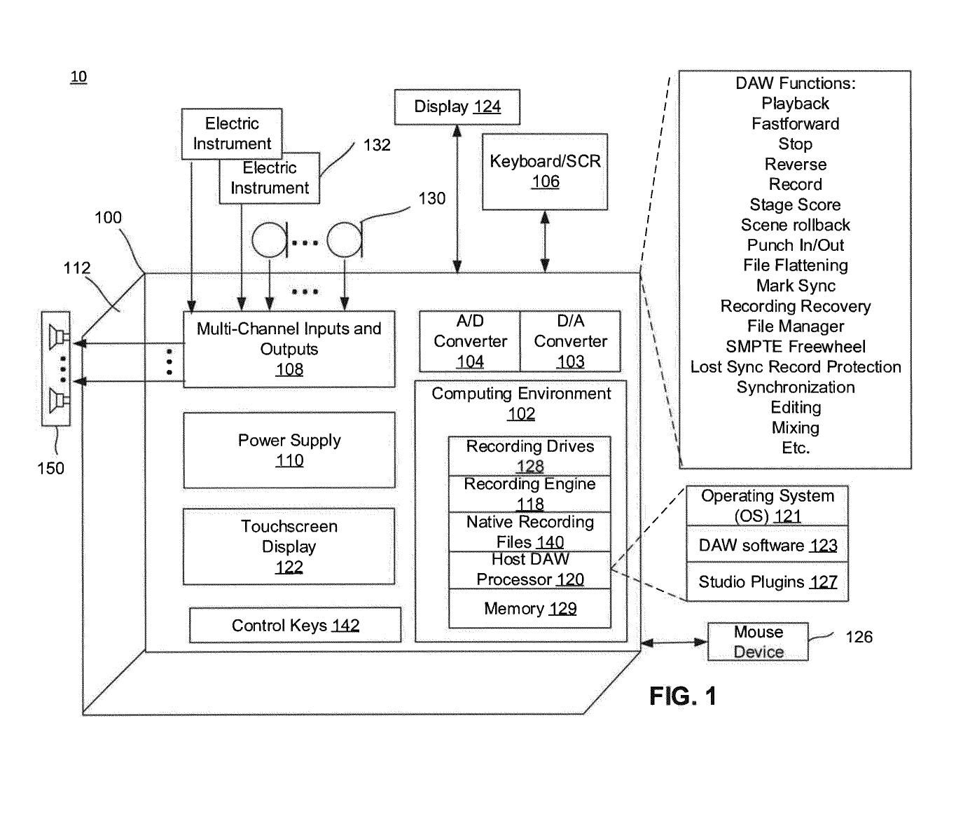

Referring now to FIG. 1, a block diagram of a studio system 10 with a standalone integrated digital audio workstation (DAW) 100 (hereinafter referred to as “the DAW”), according to an aspect of the disclosure, is shown.

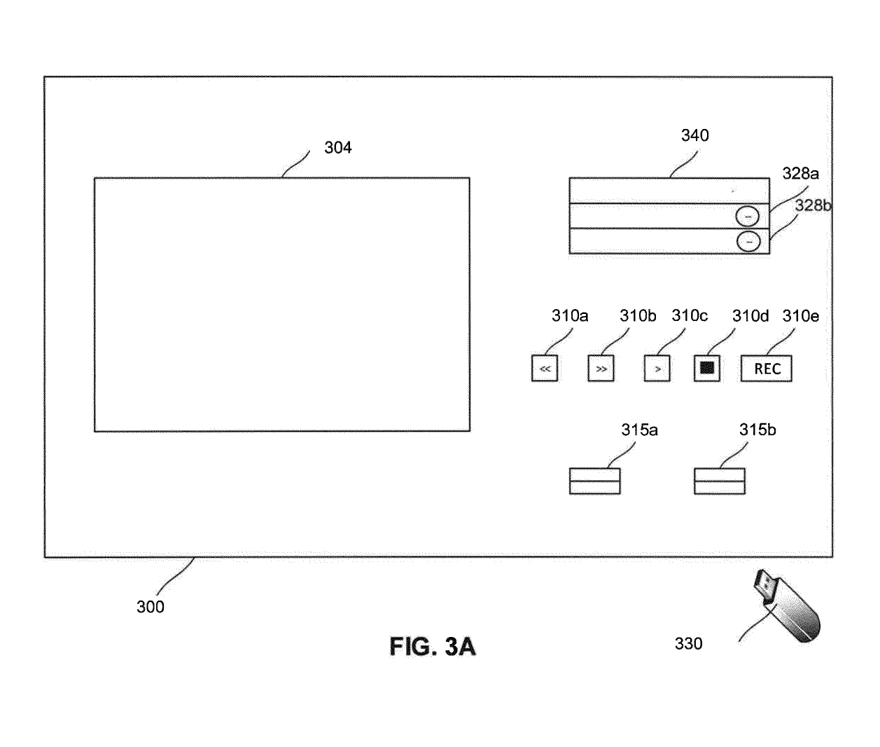

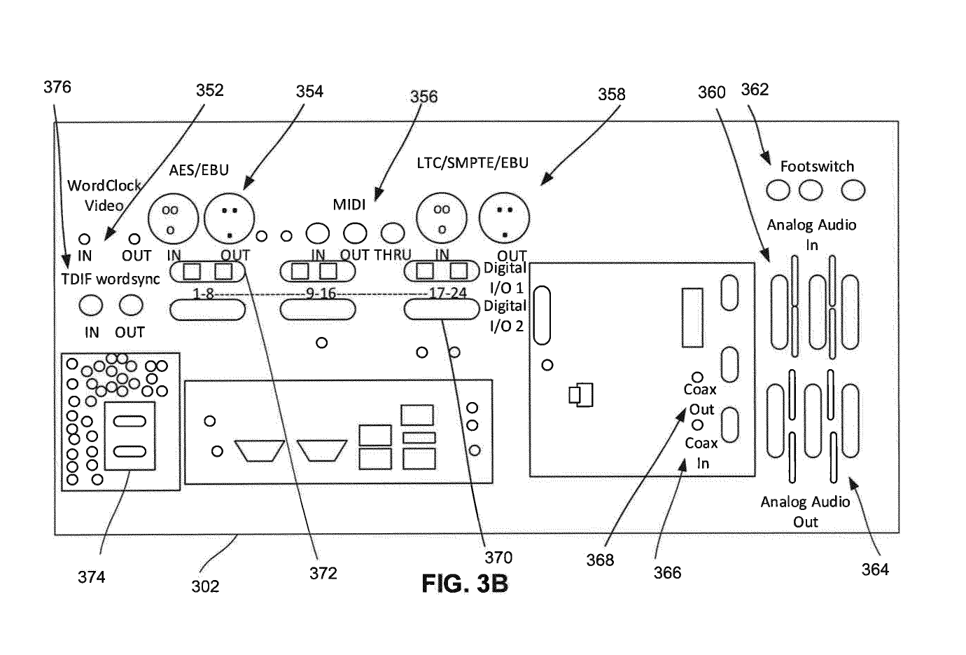

The DAW 100 is configured to facilitate multitrack recording of a musical performance or other audio performance and subsequent editing, mixing, or other manipulation and augmentation within a single housing 112. The single housing 112 generally shown collectively in FIGS. 3A and 3B. The single housing 112 providing an enclosure of the components of the DAW 100.

The system 10 may include audio pickups such as microphones 130, electric instruments 132 and the like are removably connected to DAW 100 at a plurality of multi-channel inputs and outputs 108. The plurality of multi-channel inputs and outputs 108 are communicatively connected to a computing environment 102. The DAW 100 comprises software components and hardware components including multi-channel A/D and D/A converters 104 and 103 which function to record inputs (input audio or sound signals) from inputs of one or more of the multi-channel inputs and outputs 108 and store such recordings in one or more native recording files 140 in a recording media. In a DAW mode, mixing the channels/tracks of the native recording files 140 is output to the D/A converters 203 using the low jitter clock (i.e., clock 219), via the recording engine 118, to a plurality of speakers 150. In an aspect of the disclosure, the speakers 150 of DAW system 10 may be separate from the housing 112 of the DAW 100.

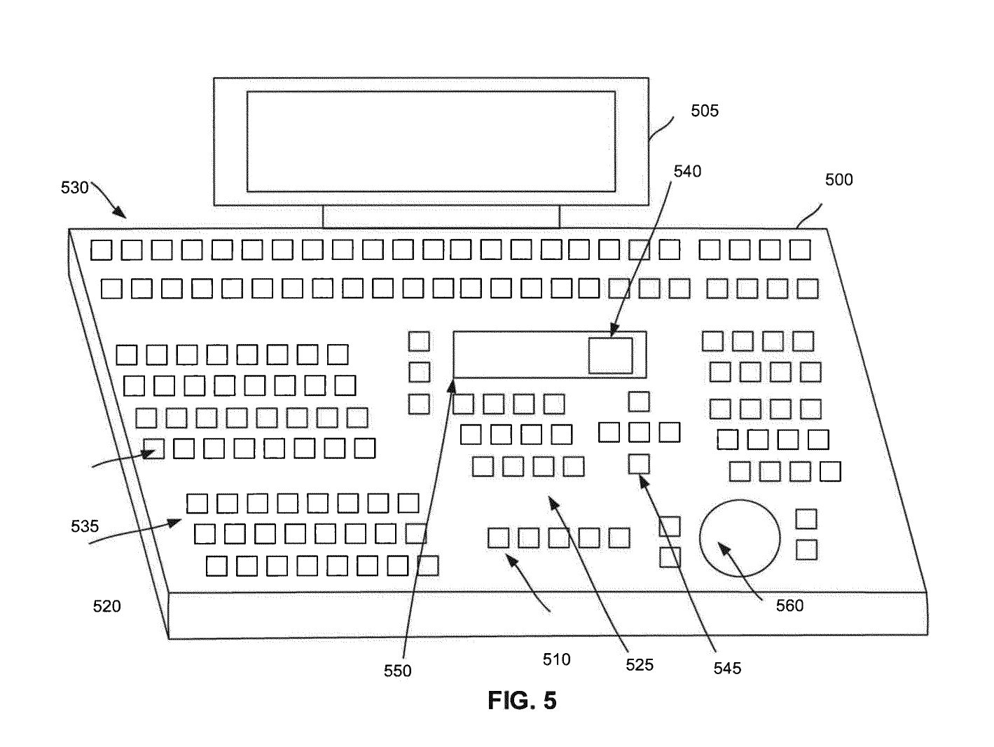

By way of non-limiting example, computing environment 102 includes a recording engine 118 configured to record multi-channel inputs and process tracks recorded by each of the multi-channel inputs and outputs 108, syncs such tracks, and enables a user to playback, edit and otherwise manipulate such recorded tracks (i.e., native recording files 140) via a user interface. In an embodiment, the user interface may include an internal touchscreen display 122 integrated with the single housing 112. However, the user interface may further include without limitation control keys 142, described in more detail in FIG. 3A. In other aspect, the user interface of system 10 may further include external computer display 124, a keyboard 106 (i.e. a session controller remote (SCR) of FIG. 5) and other input or output devices attached to or integral to the DAW 100. The session controller remote (SCR) may be a dedicated tactile remote controller with multi-channel meterbridge (i.e., meterbridge 505) integrated directly into the DAW workflow. A mouse 126 may be interfaced with the DAW 100.

While other user interfaces may be used and connected through the housing 112, the DAW 100 is a standalone device with a user interface (i.e., touch screen display 122 and/or control keys 142) to control the operation of the DAW 100 affixed to the housing 112. Such additional devices will be apparent to those skilled in the relevant art(s) after reading the description herein.

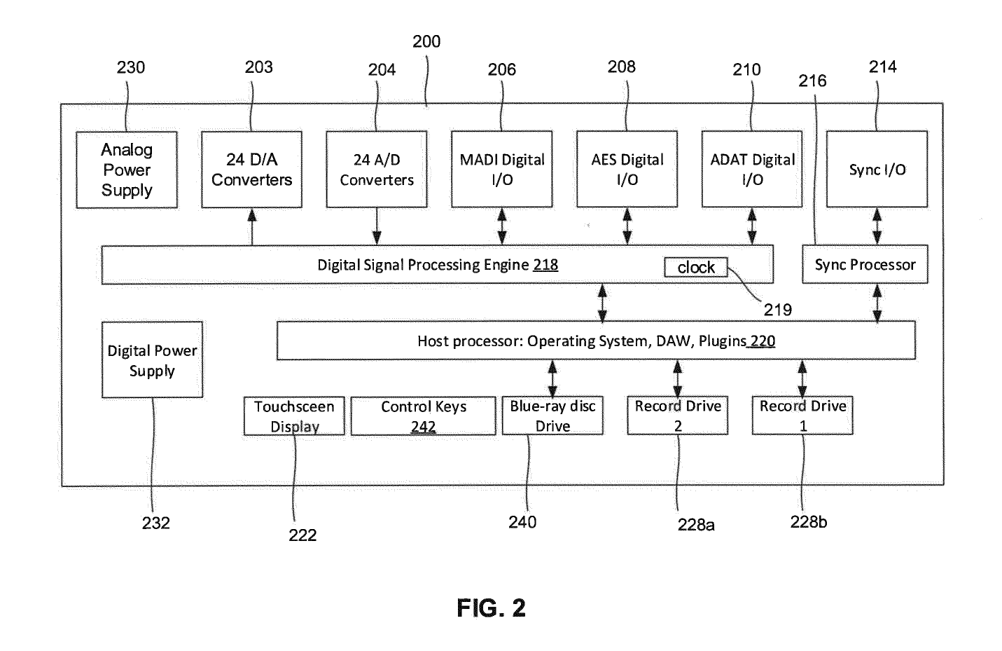

The DAW 100 further includes one or more power supplies 110 and power connections (not shown in FIG. 1) which provide power to other portions of the DAW 100, as will be described in more detail in relation to FIG. 2.

The computing environment 102 further comprises a host DAW processor 120 configured to process native recording files 140. The host DAW processor 120 includes a native operating system (OS) 121, DAW software 123 and studio plugins 127. The DAW software 123 and plugins 127 may include one or more of Pro Tools by Avid Technology, Inc., Nuendo, REAPER, Mixbus, etc. The tools and processing platforms of the DAW software and plugins 127 are well established. For the sake of brevity, the DAW software which when executed performs audio editing, processing, and track or channel audio mixing to create a final master production of recording files.

In an aspect, computing environment 102, touchscreen display 12, multi-channel inputs and outputs 108 and power supply are all housed within a single housing 112, enclosure or box. The DAW processing uses a native operating system configured to selectively process directly the native recorded files 140 created within the computing environment 102. The housing 112 is generally portable and can be placed on a desk, table, or workstation surface.

In an aspect, portions of computing environment 102 are upgradable. The touchscreen display 122 may be swapped for a higher-resolution display, additional RAM or memory 129 may be added, processors may be changed, and the like, according to manufacturer specifications and suggestions. Thus, the memory 129 and recording drives 128 may be shared by both the recording engine 118 and the host DAW processor 120.

Based on the additional description below, additional functions of the DAW include Playback, Fast-forward, Stop, Reverse, Record, Stage Score, Scene rollback, Punch In/Out, File Flattening, Mark Sync, Recording Recovery, File Manager, SMPTE Freewheel, Lost Sync Record Protection, Synchronization, Editing, Mixing, etc.

The details of the computing environment 102 of the DAW 100 will be described in further detail in relation to FIG. 2.

Referring now to FIG. 2, a block diagram of a DAW 200, according to an aspect of the disclosure, is shown.

In an aspect, a pre-configured, self-contained DAW 200 is incorporated into a single housing with a separate optional keyboard/SCR 106 attached. The DAW 200 comprises hardware including multi-channel A/D and D/A converters 204 and 203 enabling multiple channels to be recorded simultaneously at up to a 192 kHz sample rate, analog and digital power supplies 230, 232, a host processor 220 having an operating system (e.g., Linux, Windows, a dual boot environment), memory storing a digital audio workstation (DAW) software suite and any desired plugins operating within the operating system, a networking interface (i.e., network interfaces 420), drivers for a display 124 (FIG. 1) and input devices such as a touchscreen display 122 (FIG. 1), and a keyboard/SCR 106 (FIG. 1).

In an aspect, an original equipment manufacturer (OEM) version of the operating system (OS) is chosen and a digital audio workstation (DAW) software suite is chosen which is configured for operation in Windows in order to take advantage of the Window's audio stream input/output (ASIO) driver and processor thread authority protocols. Via the ASIO driver, absolute authority over such threads is necessary to process inputs from input channels at a 192 kHz rate. Other operating systems which provide processor thread authority protocols, such as the Linux operating system, may be used. Other operating systems fail to consistently sample at 192 kHz due to lack of control over processor operation at such a detailed level.

In an aspect, host processor 220 has a 64-bit architecture.

Digital power supply 232 may be a low noise high efficiency power supply. Analog power supply 230 may be a fanless power supply.

DAW 200 comprises a host processor 220, one or more recording drives 228a and 228b, a sync processor 216 communicatively coupled to a time code sync I/O 214, and a digital processing engine 218 (i.e., recording engine 118). Recording drives 228a and 228b are computer storage media (hereinafter sometime referred to as “recording media”) communicatively coupled to host processor 220 for storing audio tracks during the recording mode of operation. In an aspect, recording drives 228a and 228b are solid state hard drives. The recording media being accessible during the DAW mode of operation as will be described in more detail later. The recording drives 228a and 228b may include two or more key-lock removable solid state high performance SATA III record drives.

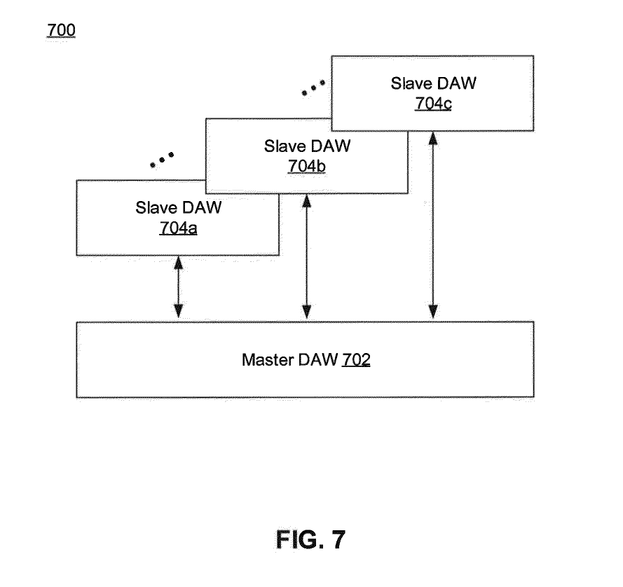

The sync processor 216 may be used for SMPTE and MIDI time code synchronization, as well as MIDI machine control, Sony 9 pin machine control, and DAWMULTI-Link, which allows the connection and operation of up to eight DAWs to operate as a single 192 track recorder connected to a master DAW. The DAWMULTI-Link is in the sync I/O 214. The slave DAWs do not require DAW software and plugins. (See FIG. 7). The Sync Processor 216 may include a synchronization processor that provides SMPTE freewheel and JAM syncing, as wheel as MTC flywheel for ultra-smooth SMPTE and MTC lock up and low jitter clock recovery. The Sync Processor 216 may provide MIDI and SMPTE time code positional synchronization of the DAW with other 3^{rd} party recording equipment or slave DAWs.

The DAW 200 may further comprises a media device such as a Blu-ray disc drive 240 capable of creating removable computer storage media within the computing environment 102. Host processor 220 may be communicatively coupled to display 124 and keyboard/SCR 106. Touchscreen display 222 may comprise two connections, an input touchscreen connection for receiving user commands and a display connection for outputting visual and text information to the user. A digital power supply 232 provides power to portions of computing environment and specifically the digital signal processing engine 218 and the host processor 220. The control keys 242 (i.e., control keys 310a-310e) control the recording functions as described in more detail in FIG. 3A. The control keys 242 may be used in both the recording mode and the DAW mode.

The multi-channel inputs and outputs 108 may be communicatively coupled to digital signal processing engine 212 via a plurality of digital-to-analog (D/A) converters 203 and a plurality of analog-to-digital (A/D) converters 204. The D/A and A/D converters may include Ultra-Nyquist or Classic 96 converters. The plurality of converters may be 8, 16 or 24 A/D converters and 8, 16 or 24 D/A converters. The DAW 200 may further include inputs and outputs which are compatible with Multichannel Audio Digital Interfaces (MADI) 206, an audio engineering society (AES) digital I/O interface 208 and an Alesis Digital Audio Tape (ADAT) I/O interface 210.

in an aspect, D/A converters 203 may comprise a plurality of channels capable of up to 192 kHz sample rate on all channels. A/D converters 204 may comprise a plurality of channels capable of up to 192 kHz sample rate on all channels. The MADI 206 may comprise a plurality of channels (i.e., 24 channels) at up to a 96 kHz sample rate or 16 channels of I/O at 192 kHz sample rate. AES digital I/O interface 208 may comprise a plurality of channels (i.e., 24 channels) at up to a 96 kHz sample rate or 12 channels of I/O at 192 kHz sample rate. ADAT I/O interface 210 may comprise a plurality of channels (i.e., 24 channels) at up to 48 kHz sample rate or 6 channels of I/O at 192 kHz sample rate.

The digital signal processing engine 218 of DAW 200 serves as a recording engine (i.e., ADRENALINE DR recording engine) which uses a high resolution frequency-synthesized digital phase lock loop (FSD-PLL) to produce digital recording fidelity. The digital signal processing engine 218 (i.e., recording engine) may include a field programmable gate array (FPGA) that is programmed at each system boot up with firmware. with its frequency synthesized digital PLL to provide an near-zero jitter clock 219, super low latency audio routing, and real time crossfades on all channels during punch in/out at all sample rates up to 192 kHz. The digital signal processing engine 218 (i.e., recording engine) frees up the host processor 220 to provide better DAW/plugin performance. The DAW 200 has near-zero jitter. Musicians can track, edit and mix in the box with DAW software in DAW mode.

In the DAW 200, the audio comes to life through A/D and D/A converters. The A/D and D/A converters may connect to Logic, Nuendo, REAPER and other native DAW software via low-latency and low-jitter MADI digital I/O.

Each A/D and D/A converter is made with 8, 16 or 24 channel configurations with customizable I/O ratios. A/D and D/A converters 204 and 203 may be re-configured I/O ratios and add channel-count, as needed. The host processor 220 may use another DAW processor card.

Additional aspects of the DAW 200 may include, but are not limited to interfaces, hardware and/or software for a word clock, video synchronization, Sony/Phillips Digital Interface Format (SPDIF), Society of Motion Picture and Television Engineers (SMPTE) and musical instrument digital interface (MIDI) time code synchronization with freewheel averaging. Additional to interfaces, hardware and/or software may include without limitation video monitor interfaces, RS232 interfaces, and PCI or PCIe interfaces.

The DAW 200 may include third party processing or interface cards such as those available from Universal Audio or Audinate.

The DAW 200 provides music recording engineers with a comprehensive, pre-configured self-contained, recording studio tool in a single box or housing, allowing them to record, edit, process, and mix music with a simple workflow and a professional level of sound quality at up to 192 kHz sample rate with ultra-low jitter conversion clock signals, and low latency processing. The “closed” nature of the DAW 200 prevents users from compromising factory prescribed configurations and authorized installations, thereby enabling a user to purchase the DAW 100 or DAW 200 and quickly begin recording and editing without first gathering system requirements, sourcing materials and assembling a tool. Additional system functions in addition to those described above will now be described.

Whether it's being used as the recorder in a recording mode for a scoring stage or as a stem recorder for audio post-production, the DAW 200 has fast lock times, ultra-low jitter clocking, and easy workflow integration ensure projects are completed quickly and easily. The DAW 200 may allow for scoring stages. The DAW 200 may include “RECORD ON CHASE” and “PROJECT PER TAKE” features which automate the scoring stage process. Roll back the scene and record it again and again Wherein the DAW 200 is configured to punch in and out and automatically creating and labeling new takes.

The DAW 200 is configured for audio post production. In the DAW mode, the DAW 200 may create and utilize the native broadcast wave (BWAV) file format with the DAW software. The system is configured to, in the recording mode, records natively to an audio file, such as without limitation, a BWAV formatted audio file. The DAW 200 is configured to use the native audio file (i.e., BWAV formatted audio file) with the DAW software using the embedded A/D and D/A converters.

The DAW 200 is configured to create seamless punches and file flattening which may make it faster and easier to edit and consolidate overdubs.

The DAW 200 is configured to acquire speed and positional referencing from a variety of sync sources including without limitation: (linear or longitudinal time code) LTC, (MIDI time code) MTC, Video Sync, Word Clock, and AES/EBU (European Broadcasting Union). LTC can be chased in both forward and reverse directions such as without limitation for film applications. The system's internal clock circuitry features multiple dedicated, application-specific PLLs. The DAW 200 may use differential clock lines for noise rejection meaning a cleaner, more stable clock signal.

The DAW 200 may include a mark sync feature configured to add an additional marker to an audio region. This mark sync feature may makes it easy to place sounds and sound effects precisely at spotted time code locations. The DAW 200 may include a Sony 9-pin machine control slip-lock-to-video implementation which “glues” audio to the picture for frame-accurate synchronization and virtual instant lock.

The keyboard/SCR of system 10 may include programmable macro keys for use in the DAW mode to allow users to increase speed and enhance productivity by eliminating repetitive keystrokes. The DAW 200 may include dual disk recording operation via the recording drives 228a and 228b. At the end of a session, the DAW 200 may be configured to provide an instant backup of the master tracks. Give one disk to the client, and keep the other for safety or backup.

The DAW 200 may include a MAIM option board with a dual Coax/Optical interface. The DAW 200 may be configured with daisy-chainable MADI I/O that presents multiple RADAR units to digital mixing engines as a single, interleaved MADI port. The DAW 200 may include record recovery mode, wherein the DAW 200 updates essential file information during recording which allows for easy recovery of audio in the event of a venue power failure. The DAW 200 may include MADI board with dual Coax/Optical interface. The system may daisy-chain MADI I/O with a plurality of slave DAWs wherein the master DAW would perform mixing.

The DAW 200 may include a file manager to give clients performance files quickly and easily. By way of non-limiting example, the file manager may allow drag and drop capability of flattened BWAV recording files into an external Firewire or USB drive 315a or 315b.

The DAW 200 may include SMPTE Freewheel and Lock and Drop modes to ensure that disappearing time code will not affect the record. For example, the DAW 200 may include a “Lost Sync” record protection to keep the recording rolling, even after the complete loss of video, word clock, or AES sync. The DAW 200 may automatically mark and label the drop out point to give the user a heads-up during the mix.

The DAW 200 may include a playback function. In playback environments, a player's ability to synchronization and direct audio, video, and automation can make or break a show. The DAW 200 may control playback over Ethernet with Network Control (NC) software and protocol or with RS232, MIDI and Sony 9 Pin for virtually any theme park, show control, or theatre application.

The DAW 200 may include standard and custom theatre-mode settings to provide locate and transport control macros to be integrated into any show. The DAW 200 may automatically locate after play, cue, and re-locate as well as remotely trigger macros and events via MIDI, 9 pin or NC.

The DAW 200 may automate any playback environment by recalling millions of sound clips and hundreds of projects locally or remotely. The DAW 200 may query playback status, project information, and update machine settings over Ethernet on multiple machines from one remote location.

The DAW 200 may include routing macros that automatically route tracks, inputs and outputs locally or remotely, based on user selection. The DAW 200 may include footswitch jacks to control playback with instant Stop/Play, Record Punch, and Last Locate cueing and response times.

Referring now to FIGS. 3A and 3B, are a front panel 300 and a back panel 302 of the housing of the standalone integrated DAW 100, according to an aspect of the present disclosure, are shown. In general the housing of the DAW 100 includes at least four sides, a top side and a bottom side. Other enclosure configurations are contemplated.

The DAW 100 is equipped with a touchscreen display 304 on the front panel, allowing the user to interact with native DAW editing software, such as ProTools. The DAW 100 may include a plurality of control keys 310a, 310b, 310c, 310dand 310e to control a recording, track or channel. The control key 310a is a reverse or rewind key which reverses a recording. The control key 310b is a fast forward key which advances a recording forward in a fast speed. The control key 310c is a playback key to play a recording or track at a standard rate. The control key 310d is a stop key to stop the playback. The control key 310e is a record key which when activated records one or more armed channels or tracks from the multi-channel inputs and outputs 108. The DAW 100 may include variety of inputs and outputs, as shown, enabling a single recording and mixing device to be used.

The front panel 300 may include USB ports 315a and 315b configured to receive a removable USB drive 330. The front panel 300 may include a Blue-ray drive 340 and recording drives 328a and 328b.

The back panel 302 includes ports and jacks for audio, video and a power port 374. By way of non-limiting example, the ports and jacks include Analog Audio In 360 and Analog Audio Out 364, Coax In 366, Coax Out 368, TDIF word sync In and Out 376, first digital I/O for a plurality of channels 370 and second digital I/O 372. Additional aspects of DAW 100 include, but are not limited to a word clock In and Out 352, video synchronization, Audio Engineering Society (AES) interfaces 354, Sony/Phillips Digital Interface Format (SPDIF), Society of Motion Picture and Television Engineers (SMPTE) 358 and musical instrument digital interface (MIDI) 356 time code synchronization with freewheel averaging, and footswitches 362.

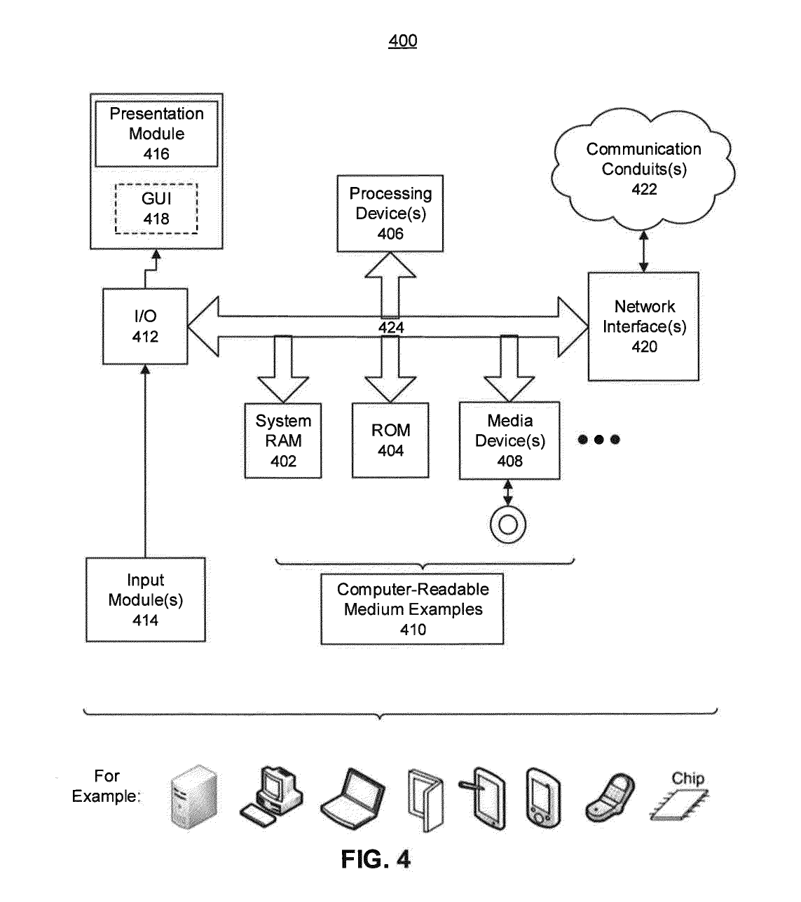

Referring now to FIG. 4, a block diagram of an exemplary computer system useful for implementing various aspects the processes disclosed herein, in accordance with one or more aspects of the present disclosure, is shown.

That is, FIG. 4 sets forth illustrative computing functionality 400 that may be used to implement processes all of or portions of the DAW 100 and DAW 200. In all cases, computing functionality 400 represents one or more physical and tangible processing mechanisms.

Computing functionality 400 may comprise volatile and non-volatile memory, such as RAM 402 and ROM 404, as well as one or more processing devices 406 (e.g., one or more central processing units (CPUs), one or more graphical processing units (GPUs), and the like). Computing functionality 400 also optionally comprises various media devices 408, such as a hard disk module, an optical disk module, and so forth. Computing functionality 400 may perform various operations identified above when the processing device(s) 406 execute(s) instructions that are maintained by memory (e.g., RAM 402, ROM 404, and the like).

More generally, instructions and other information may be stored on any computer readable medium 410, including, but not limited to, static memory storage devices, magnetic storage devices, and optical storage devices. The term “computer readable medium” also encompasses plural storage devices. In all cases, computer readable medium 410 represents some form of physical and tangible entity. By way of example, and not limitation, computer readable medium 410 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 402, ROM 404, EEPROM, Flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 400 may also comprise an input/output module 412 for receiving various inputs (via input modules 414), and for providing various outputs (via one or more output modules). One particular output module mechanism may be a presentation module 416 and an associated GUI 418. Computing functionality 400 may also include one or more network interfaces 420 for exchanging data with other devices via one or more communication conduits 422. In some embodiments, one or more communication buses 424 communicatively couple the above-described components together.

Communication conduit(s) 422 may be implemented in any manner (e.g., by a local area network, a wide area network (e.g., the Internet), and the like, or any combination thereof). Communication conduit(s) 422 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices. The features of the present disclosure described herein are platform-independent, meaning that the techniques can be implemented on a variety of commercial computing platforms having a variety of processors (e.g., set-top box, desktop, laptop, notebook, tablet computer, personal digital assistant (PDA), mobile telephone, smart telephone, gaining console, and the like).

FIG. 5 is a diagram of a session controller remote (SCR) 500 with meterbridge 505 according to an aspect of the disclosure.

The SCR 500 provides complete remote control of the DAW 100 as well as access to basic functions such as backup and restore. SCR 500 is a mouse-less interface and includes one-button remote functions and jog-wheel editing.

The SCR 500 has a tape machine style interface with auto-locator controls. The SCR can be used to control up to 8 DAW slaves, for a total of 192 tracks. The SCR 500 includes a modular (add-on) meterbridge 505 or display. The meterbridge may include 24 or 48 channels.

The SCR 500 includes dedicated keys for transport control, track arming, soloing, editing, project management, and many other functions. The SCR 500 includes dedicated macro keys for user-programmed operational sequences, Jog/Shuttle wheel 560, and character and numeric display 550 for video monitor-free operation.

The SCR 500 includes alphabet keys 520, number keys 525, control keys 510, individual track or channel keys 530, function keys 535, CPU indicator 540, navigation keys 545, and display 550.

The meterbridge 505 provides instant and highly accurate input level indication for all 24 or 48 channels of Linked audio. Each individual meter has a plurality of light emitting diodes (LEDs) such as green and yellow LED (for levels), plus additional LEDs for clip, arming, input, solo, and edit indication. The LEDs may be calibrated to display a logarithmic scale such as without limitation from 0 dB down to −55 dB.

The meterbridge 505 may display as a visual indication audio levels, track arms, input, edit, and solo. The display may include three color LED display and clip-indicator LEDs. The meterbridge 505 may display a peak hold. The display 560 may serve to indicate named macro keys and other functionality states of the SCR 500.

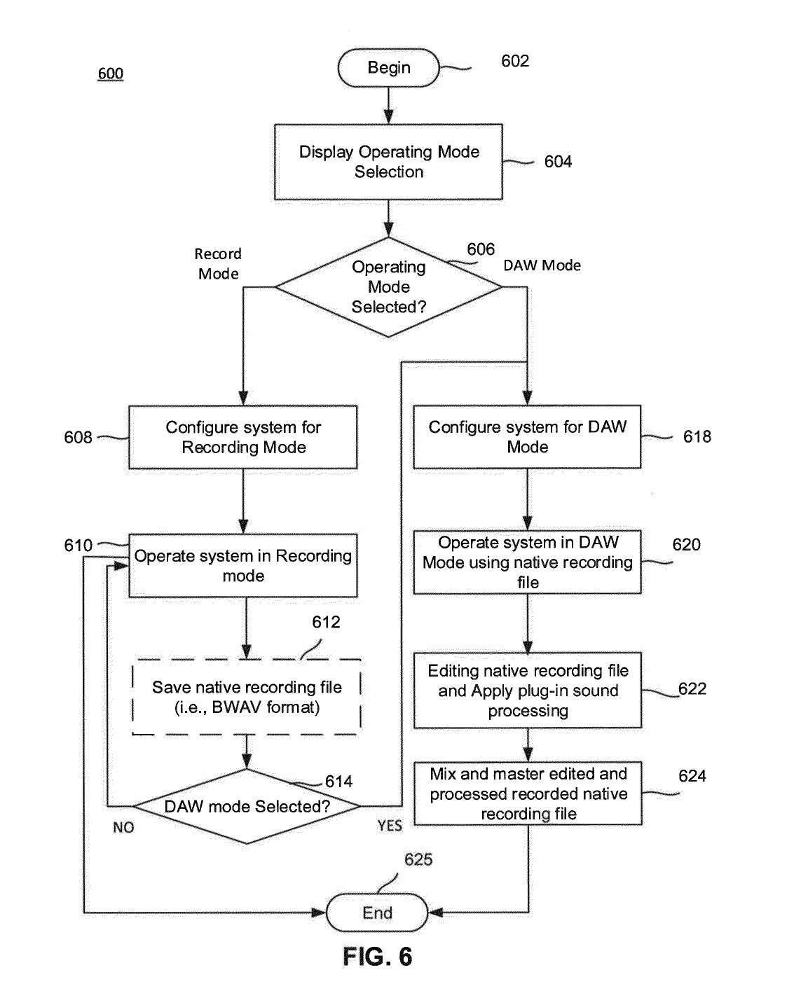

FIG. 6 is a flowchart of a dual mode integrated DAW system operational process 600 according to an aspect of the disclosure.

The process begins at 602. Upon powering the DAW 100, an operating mode selection may be displayed at 604 to the user. The operating mode options may include recording mode or DAW mode. A determination may be made whether a recording mode or DAW mode is selected at 606. If the determination is recording mode, the process proceeds to block 608 where the DAW 100 and DAW 200 are configured for recording operation using a recording engine. The keyboard/SCR 500 has keys which have functions which may change based on the mode.

At block 610, the DAW 100 or DAW 200 is operated to record audio, playback audio, reverse audio, fast-forward audio and other functions described previously associated with recording audio from multiple inputs. At block 612, the recording is stored as a native recording file.

At block 614, a determination is made whether DAW mode is selected. If the determination is NO, the operation of the DAW 100 or DAW 200 continues in the record mode. The term audio may be a compilation of multiple channels or tracks or a single channel or track.

If the determination at block 614 is YES, meaning, DAW mode is selected, the recorded file is a native recorded file (i.e., BWAV file) is recorded or saved. Thereafter, the process 600 loops to block 618 where the system is configured for the DAW mode. The SCR keys may be configured for the DAW mode and/or stored macros for DAW user programmable operations may be initialized. At block 620, the DAW 100 or DAW 200 operated according to the DAW software suite of tools to edit and mix tracks of audio.

At block 622, the native recording file(s) are edited and/or plug-in sound processing is applied to the native recording file(s) or the edited native recording file(s). At block 624, the edited and/or processed native recording file(s) are mixed and master edited to produce a master production recording file of a plurality of audio tracks.

At block 625, the process 600 ends. In operation, for a single project, the DAW 100 or DAW 200 can record first and then change the mode of operation to use the native DAW software tools and plug-ins to edit, mix and produce a final master production file.

The steps shown may be performed in the order shown or another order. One or more of the steps may be performed contemporaneously. Additional steps may be added or omitted.

In operation, some record mode functions are imparted to the DAW mode. For example, the control keys 310a-310e may be used in both modes. Additionally, the DAW 100 may be configured to determine CPU processing levels of host processor 220. By way of non-limiting example, the DAW 100 may identify a CPU processing limit over a predetermined threshold so that corrective action can be performed. The CPU indicator may be displayed via display 545.

FIG. 7 is a networked integrated DAW system 700, according to an aspect of the disclosure.

System 700 includes a master DAW 702 and a plurality of slave DAWs 704a, 704b and 704c. In an aspect of the disclosure, eight DAWs may be linked for up to 192 channels or tracks of individual inputs. The master DAW 702 may be configured as system 10 with inputs, speakers and other user interfaces.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A standalone integrated digital audio workstation (DAW) comprising:
a single housing;
embedded multi-channel analog-to-digital (A/D) and digital-to-analog (D/A) converters within the single housing;
a recording engine, coupled to the A/D and D/A converters for recording multiple tracks of audio at one or more sampling rates using a near-zero jitter clock signal in a record mode;
recording media for storing the multiple tracks to create native recording files during the recording mode; and
one or more processors, within the single housing, to edit, mix, and prepare final production files without the use of a separate computer in a DAW mode using directly the native recording files wherein the DAW has a low aggregate latency.

2. The standalone integrated DAW of claim 1, wherein the one or more sampling rates is up to 192 kHz.

3. The standalone integrated DAW of claim 1, further comprising a user interface integrated into the single housing for selectively performing editing, mixing and preparing final production files.

4. The standalone integrated DAW of claim 3, wherein the user interface includes a session controller remote (SCR) comprising a keyboard for operation in the DAW mode and the record mode.

5. The standalone integrated DAW of claim 1, further comprising a plurality of inputs and outputs compatible with one or more of Multichannel Audio Digital Interfaces (MADI), an audio engineering society (AES) digital I/O interface and an Alesis Digital Audio Tape (ADAT) I/O interface.

6. The standalone integrated DAW of claim 5, further comprising a plurality of control keys, the plurality of control keys include a reverse or rewind operation, a fast forward or advance key, a playback key to play a recording or track, a stop key to stop the playback, wherein the control keys are operational in the record mode and the DAW mode.

7. The standalone integrated DAW of claim 1, further comprising recording drives configured to be operational in the DAW mode and the recording mode.

8. A standalone integrated digital audio workstation (DAW) system comprising:
a DAW in a single housing and having a low aggregate latency comprising:
embedded multi-channel analog-to-digital (A/D) and digital-to-analog (D/A) converters within the single housing;
a recording engine, coupled to the A/D and D/A converters for recording multiple tracks of audio at one or more sampling rates using a near-zero jitter clock signal in a record mode;
recording media for storing the multiple tracks to create native recording files during the recording mode; and
one or more processors, within the single housing, to edit, mix, and prepare final production files without the use of a separate computer in a DAW mode using directly the native recording files; and
a dual mode session controller remote coupled to the single housing and configured to control operations of the recording engine in the recording mode and the one or more processors in the DAW mode.

9. The system of claim 8, wherein the one or more sampling rates is up to 192 kHz.

10. The system of claim 8, further comprising a user interface integrated into the single housing for selectively performing editing, mixing and preparing final production files.

11. The system of claim 8, further comprising a plurality of inputs and outputs compatible with one or more of Multichannel Audio Digital Interfaces (MADI), an audio engineering society (AES) digital I/O interface and an Alesis Digital Audio Tape (ADAT) I/O interface.

12. The system of claim 8, further comprising a plurality of control keys, the plurality of control keys include a reverse or rewind operation, a fast forward or advance key, a playback key to play a recording or track, a stop key to stop the playback, wherein the control keys are operational in the record mode and the DAW mode.

13. The system of claim 8, further comprising recording drives configured to be operational in the DAW mode and the recording mode.

14. The system of claim 8, wherein the DAW is a master DAW; and
further comprising a plurality of slave DAWs linked for up to 192 channels or tracks of individual audio inputs to be recorded in the recording mode.

15. A method comprising:
providing a digital audio workstation (DAW) in a single housing, the DAW comprising embedded multi-channel analog-to-digital (A/D) and digital-to-analog (D/A) converters within the single housing; a recording engine, coupled to the A/D and D/A converters for recording multiple tracks of audio at one or more sampling rates using a near-zero jitter clock signal in a record mode; recording media for storing the multiple tracks to create native recording files during the recording mode; and one or more processors, within the single housing, to edit, mix, and prepare final production files in a DAW mode using directly the native recording files wherein the DAW has a low aggregate latency;
recording with the DAW in the recording mode to create the native recording files; and
editing and mixing the native recording files in the DAW mode without use of a separate of a separate computer.

16. The method of claim 15, wherein the DAW is a master DAW; and
further providing a plurality of slave DAWs;
wherein the method further comprising linking up to 192 channels or tracks of individual audio inputs;
wherein the recording includes recording in the recording mode to the 192 channels or tracks; and
wherein the editing and mixing includes editing and mixing one or more of the 192 channels or tracks.

17. The method of claim 15, wherein the DAW further comprising a plurality of control keys, the plurality of control keys include a reverse or rewind operation, a fast forward or advance key, a playback key to play a recording or track, a stop key to stop the playback, wherein the control keys are operational in the record mode and the DAW mode.

18. The system of claim 15, wherein the one or more sampling rates is up to 192 kHz.
